(19) United States
(12) Patent Application Publication
(10) Pub. No.: US 2014/0310801 A1
(43) Pub. Date: Oct. 16, 2014

(54) Method and Apparatus for Performing Authentication

(71) Applicant: NOKIA CORPORATION, Espoo (FI)

(72) Inventors: Antila Mika Juhani, Pirkkala (FI); Saukko Jari Olavi, Tampere (FI); Janne Bergman, Tampere (FI); Petteri Kauhanen, Espoo (FI)

(21) Appl. No.: 13/861,356

(22) Filed: Apr. 11, 2013

(51) Int. Cl. G06F 21/40

(52) U.S. Cl. CPC G06F 21/40
USPC 726/19

(57) ABSTRACT

A method comprising determining at least one three dimensional representation of at least one object proximate to an apparatus, and performing authentication based, at least in part, on the three dimensional representation is disclosed.

### TECHNICAL FIELD

The present application relates generally to performing authentication.

### BACKGROUND

As electronic apparatuses play a larger role in the lives of their users, users have come to rely on electronic apparatuses for many things. For example, users may rely on the electronic apparatus for storing confidential information, such as personal information, secret information, etc. In another example, users may rely on the electronic apparatus to identify themselves to other users or other apparatuses. In such an example, a mobile phone may provide information to another mobile phone when a user sends a message or makes a phone call. It may be desirable to restrict access to electronic apparatuses. In addition, it may be desirable to perform authentication to guard against unauthorized access.

### SUMMARY

Various aspects of examples of the invention are set out in the claims.

One or more embodiments may provide an apparatus, a computer readable medium, a computer readable medium, a non-transitory computer readable medium, a computer program product, and a method for determining at least one three dimensional representation of at least one object proximate to an apparatus, and performing authentication based, at least in part, on the three dimensional representation.

One or more embodiments may provide an apparatus, a computer readable medium, a computer readable medium, a computer program product, and a non-transitory computer readable medium having means for determining at least one three dimensional representation of at least one object proximate to an apparatus, and means for performing authentication based, at least in part, on the three dimensional representation.

In at least one example embodiment, performing authentication comprises determining a correspondence between the three dimensional representation and at least part of object authentication information, and determining successful authentication based at least in part on the correspondence.

In at least one example embodiment, the correspondence relates to the three dimensional representation being within a threshold of deviation from the object authentication information.

In at least one example embodiment, the object authentication information relates to at least one of: identity of the object, classification of the object, orientation of the object, or placement of the object.

In at least one example embodiment, performing authentication comprises determining a lack of correspondence between the three dimensional representation and at least part of object authentication information, and determining failed authentication based at least in part on the lack of correspondence.

In at least one example embodiment, the lack of correspondence relates to the three dimensional representation being beyond a threshold of deviation from the object authentication information.

In at least one example embodiment, the object authentication information relates to at least one of: identity of the object, classification of the object, orientation of the object, or placement of the object.

In at least one example embodiment, performing authentication comprises performing a first authentication based, at least in part, on the three dimensional representation, and performing a second authentication.

In at least one example embodiment, the first authentication is performed after the second authentication.

In at least one example embodiment, the first authentication is performed concurrently with the second authentication.

In at least one example embodiment, the first authentication is performed before the second authentication.

In at least one example embodiment, the second authentication relates to a motion associated with the object.

In at least one example embodiment, the second authentication comprises determining a correspondence between the motion and at least part of motion authentication information, and determining successful authentication based at least in part on the correspondence.

In at least one example embodiment, the correspondence relates to the motion being within a threshold of deviation from the motion authentication information.

One or more example embodiments further perform receiving information indicative of a motion of the apparatus.

In at least one example embodiment, performing authentication comprises determining successful authentication based, at least in part, on determination that the first authentication was successful and the second authentication was successful.

In at least one example embodiment, the second authentication is based, at least in part, on a different three dimensional representation of a different object.

In at least one example embodiment, the object relates to an object holding the apparatus.

One or more example embodiments further perform determining that the three dimensional representation is indicative of the object holding the apparatus.

In at least one example embodiment, the different three dimensional representation relates to the different object being proximate to the apparatus.

In at least one example embodiment, the different object relates to an object performing an input.

In at least one example embodiment, performing authentication comprises performing a third authentication based, at least in part, on the input.

In at least one example embodiment, the second authentication is independent of the three dimensional representation.

In at least one example embodiment, the object relates to an object holding the apparatus.

In at least one example embodiment, the second authentication relates to motion of the apparatus.

In at least one example embodiment, the second authentication relates to a contact input associated with the object.

In at least one example embodiment, the contact input relates to at least one of a keypress input, a tactile input, a force input, or a touch sensor input.

In at least one example embodiment, the authentication is based, at least in part, on a part of the three dimensional representation that correlates to a part of the object that is not in contact with the apparatus.

In at least one example embodiment, the object is not in contact with the apparatus if the object is at a distance greater than a contact threshold from the apparatus.

In at least one example embodiment, the contact threshold relates to a distance beyond which a touch sensor does not perceive input sufficient to determine that a touch input occurred.

In at least one example embodiment, the three dimensional representation is indicative of the object being a hand.

In at least one example embodiment, performing the authentication comprises determining that the three dimensional representation is indicative of the object being the hand.

In at least one example embodiment, the three dimensional representation is indicative of the object being a hand holding the apparatus.

In at least one example embodiment, performing the authentication comprises determining that the three dimensional representation is indicative of the object being the hand holding the apparatus.

In at least one example embodiment, the three dimensional representation is indicative of the object being a hand performing input on the apparatus.

In at least one example embodiment, performing the authentication comprises determining that the three dimensional representation is indicative of the object being the hand performing input on the apparatus.

In at least one example embodiment, the input relates to an unlocking input.

In at least one example embodiment, the three dimensional representation comprises at least one indication of an adornment on the hand.

In at least one example embodiment, the adornment relates to at least one of: a ring or a watch.

In at least one example embodiment, performing the authentication comprises determining that the three dimensional representation is indicative of the adornment on the hand.

In at least one example embodiment, performing authentication comprises determining a correspondence between the three dimensional representation of the adornment and at least part of object authentication information, and determining successful authentication based at least in part on the correspondence.

In at least one example embodiment, the correspondence relates to the three dimensional representation of the adornment being within a threshold of deviation from the object authentication information.

In at least one example embodiment, the object authentication information relates to at least one of: an orientation of the adornment on the hand, a position of the adornment on the hand, an identity of the adornment, or a sensor characteristic of the adornment.

In at least one example embodiment, performing authentication comprises determining a lack of correspondence between the three dimensional representation of the adornment and at least part of object authentication information, and determining failed authentication based at least in part on the lack of correspondence.

In at least one example embodiment, the lack of correspondence relates to the three dimensional representation of the adornment being beyond a threshold of deviation from the object authentication information.

In at least one example embodiment, the object authentication information relates to at least one of: an orientation of the adornment on the hand, a position of the adornment on the hand, an identity of the adornment, or a sensor characteristic of the adornment.

In at least one example embodiment, at least part of the object is electrically conductive, and the three dimensional representation is, at least partially, indicative of a three dimensional representation of conductivity of the object.

One or more example embodiments further perform receiving sensor information indicative of the object.

One or more example embodiments further perform determining the three dimensional representation based, at least in part, on the sensor information.

One or more example embodiments further perform receiving sensor information indicative of movement of the apparatus with respect to the object.

One or more example embodiments further perform receiving additional sensor information, and determining another three dimensional representation based at least in part on the three dimensional information, the sensor information, and the sensor information indicative of movement.

In at least one example embodiment, the sensor information indicative of movement relates to sensor information that indicates movement of a feature of the three dimensional representation relative to the apparatus.

In at least one example embodiment, the sensor information indicative of movement relates to a motion sensor.

In at least one example embodiment, the motion sensor relates to at least one of: and accelerometer, a gyroscope, or a positioning sensor.

In at least one example embodiment, the sensor information is indicative of an electrical conduction property of the object.

In at least one example embodiment, the sensor is a capacitive sensor.

In at least one example embodiment, the sensor information is indicative of the object being in front of a display.

In at least one example embodiment, the object being in front of the display relates to the object being positioned such that a line normal to the display intersects with, at least part of, the object.

In at least one example embodiment, the at least part of the object corresponds with at least part of the three dimensional representation upon which the authentication is based.

In at least one example embodiment, the at least part of the object corresponds with every part of the three dimensional representation upon which the authentication is based.

In at least one example embodiment, the display is a touch display.

In at least one example embodiment, the sensor information is indicative of the object not being in front of a display.

In at least one example embodiment, the object not being in front of the display relates to the object being positioned such that a line normal to the display fails to intersect with at least part of the three dimensional representation upon which the authentication is based.

In at least one example embodiment, the object not being in front of the display relates to the object being positioned such that a line normal to the display fails to intersect with any part of the three dimensional representation upon which the authentication is based.

In at least one example embodiment, the three dimensional representation relates to a representation of distance from a surface of the apparatus.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus, such as an electronic apparatus 10, according to an example embodiment;

FIGS. 2A-2C are diagrams illustrating authentication according to at least one example embodiment;

FIGS. 3A-3C are diagrams illustrating a region associated with detecting an object proximate to an apparatus according to at least one example embodiment;

FIGS. 4A-4D are diagrams illustrating a three dimensional representation of an object according to at least one example embodiment;

FIGS. 5A-5D are diagrams illustrating a three dimensional representation of an object according to at least one example embodiment;

FIGS. 6A-6C are diagrams illustrating a three dimensional representation of an object according to at least one example embodiment;

FIG. 7 is a flow diagram illustrating activities associated with performing authentication according to at least one example embodiment;

FIG. 8 is a flow diagram illustrating activities associated with performing authentication according to at least one example embodiment;

FIG. 9 is a flow diagram illustrating activities associated with performing authentication according to at least one example embodiment;

FIG. 10 is a flow diagram illustrating activities associated with performing authentication according to at least one example embodiment;

FIG. 11 is a flow diagram illustrating activities associated with performing authentication according to at least one example embodiment;

FIG. 12 is a flow diagram illustrating activities associated with performing authentication according to at least one example embodiment;

FIG. 13 is a flow diagram illustrating activities associated with performing authentication according to at least one example embodiment; and

FIG. 14 is a flow diagram illustrating activities associated with performing authentication according to at least one example embodiment.

### DETAILED DESCRIPTION OF THE DRAWINGS

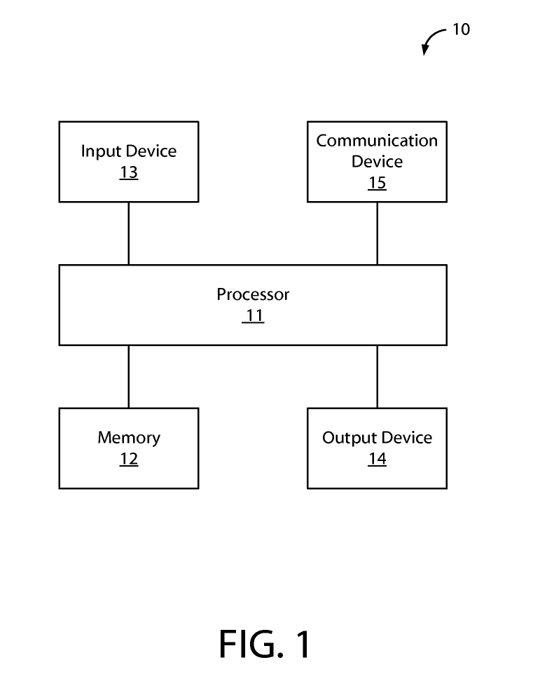

An embodiment of the invention and its potential advantages are understood by referring to FIGS. 1 through 14 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a portable digital assistant (PDAs), a pager, a mobile computer, a desktop computer, a television, a gaming apparatus, a laptop computer, a media player, a camera, a video recorder, a mobile phone, a global positioning system (GPS) apparatus, and/or any other types of electronic systems. Moreover, the apparatus of at least one example embodiment need not be the entire electronic apparatus, but may be a component or group of components of the electronic apparatus in other example embodiments.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise as an audio output device, such as a ringer, an earphone, a speaker, and/or the like. Output device 14 may comprise a tactile output device, such as a vibration transducer, an electronically deformable surface, an electronically deformable structure, and/or the like. Output Device 14 may comprise a visual output device, such as a display, a light, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

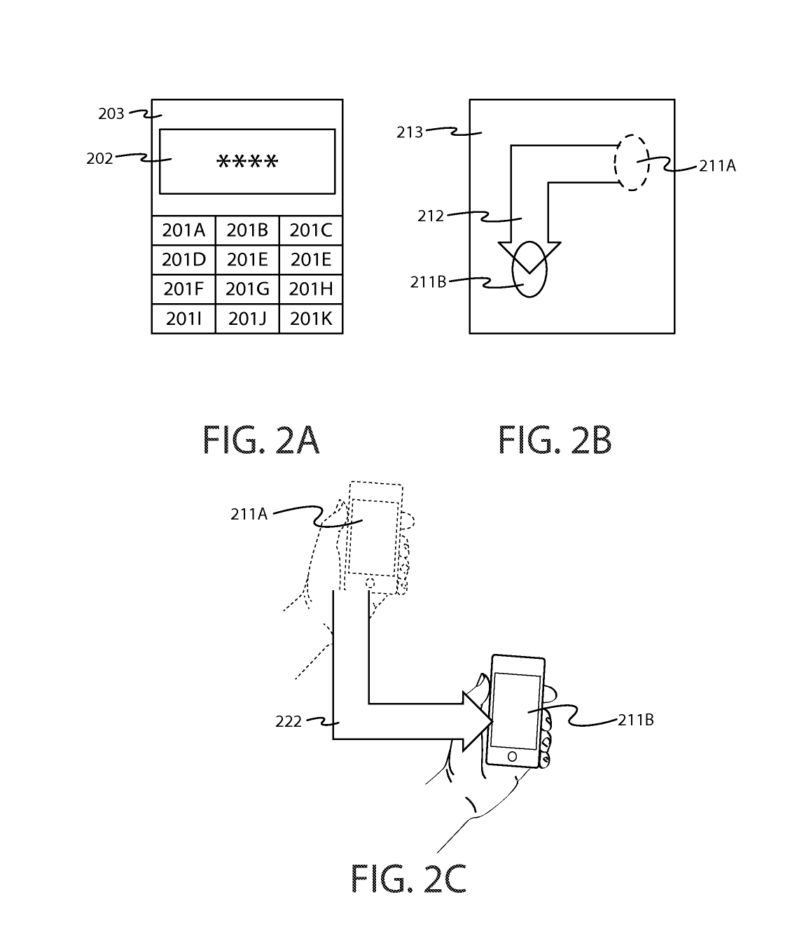

FIGS. 2A-2C are diagrams illustrating authentication according to at least one example embodiment. The examples of FIGS. 2A-2C are merely examples of authentication, and do not limit the scope of the claims. For example, type of authentication may vary, input associated with authentication may vary, displayed information associated with authentication may vary, and/or the like.

As electronic apparatuses have become more prevalent, security of electronic devices has become an increasing concern. For example, electronic apparatus may contain information that a user wishes to control or restrict access to. In such an example, a user may desire to secure messages, contact information, etc. from unauthorized viewing. Similarly, a user may desire to restrict usage of the electronic apparatus.

In at least one example embodiment, an apparatus may utilize user authentication to avoid unauthorized use of or access to an electronic apparatus. In at least one example embodiment, authentication relates to an apparatus verifying propriety of an access attempt to the apparatus. For example, an authentication may verify identity of a user, a classification of a user, and/or the like. Authentication may relate to receiving information from the user, such as a password, a gesture, and/or the like. Authentication may relate to perceiving information about a user, such as biometric information, like a fingerprint or retina pattern.

In at least one example embodiment, an apparatus performs authentication by verifying that information associated with authentication, such as input from a user, corresponds with authentication information. In at least one example embodiment, correspondence between information and authentication information relates to determining sufficient similarity between the information and the authentication information. In at least one example embodiment, similarity is sufficient if the similarity between the information and the authentication information is within a threshold of deviation. In at least one example embodiment, a threshold of deviation relates to a predetermined measurement of difference between information and authentication information that is allowable for successful authentication. For example, a threshold of deviation may relate to no deviation. In such an example, successful authentication may relate to an exact match between the information and the authentication information, such as a password. In another example, a threshold of deviation may relate to a difference indicative of an acceptable deviation. In such an example, the authentication information may relate to a gesture, and the threshold of deviation may relate to an allowable deviation that correlates to differences between successive performance of the gesture. For example, a user may perform a gesture such that there are insignificant differences across iterations of the gesture. The threshold of deviation may accommodate such differences.

In at least one example embodiment, the apparatus determines that an authentication is successful. In at least one example embodiment, a successful authentication relates to an authentication in which propriety of access has been verified. In at least one example embodiment, the apparatus determines that an authentication is unsuccessful. In at least one example embodiment, an failed authentication relates to an authentication in which propriety of access remains unverified. In at least one example embodiment, an failed authentication relates to an authentication in which propriety of access remains unverified after an attempt to authenticate. In at least one example embodiment, an apparatus determines successful authentication based, at least in part, on correlation between information and authentication information. In at least one example embodiment, an apparatus determines failed authentication based, at least in part, on lack of correlation between information and authentication information.

FIG. 2A is a diagram illustrating authentication according to at least one example embodiment. The example of FIG. 2A relates to authentication based, at least in part, on an input. The input may relate to an input associated with a key press, a contact with the apparatus, an exertion of force on the apparatus, etc. In the example of FIG. 2A, the authentication relates to a password. The example of FIG. 2A relates to a touch display 203 having password region 202 and key regions 201A-201K. Password region 202 may relate to a part of touch display 203 associated with providing an indication of input associated with the password. In the example of FIG. 2A, the characters associated with the password have been obfuscated such that the password regions include a representation indicating number of characters received in association with the password. Even though key regions 201A-201K relate to keys of a virtual keypad, any input may be used for password entry, such as a physical keypad, audio input, input from a separate apparatus, and/or the like.

In the example of FIG. 2A, the apparatus may receive input associated with the user touching touch display 203 at a position that corresponds with one of key regions 201A-201K. The apparatus may determine password information based, at least in part on the input. In at least one example embodiment, the apparatus performs authentication based, at least in part, on the password information. Since the information utilized by the apparatus in performing this type of authentication is provided for the purpose of authentication, this type of authentication may be referred to as queried authentication.

FIG. 2B is a diagram illustrating authentication according to at least one example embodiment. The example of FIG. 2B relates to authentication based, at least in part, on an input. The example of FIG. 2B relates to authentication associated with a touch gesture. In at least one example embodiment, a touch gesture relates to input associated with a touch input comprising a movement input, such as a drag input, across a touch display. The example of FIG. 2B relates to a touch display 213 upon which a touch input associated with a touch gesture was received. The touch input comprises a contact input that coincides with region 211A, a movement input 212, and a release input 211B. In at least one example embodiment, the input comprising the contact input, the movement input, and the release input relates to a continuous stroke input.

The apparatus may receive input that correlates with the input illustrated in the example of FIG. 2B. The apparatus may determine a touch gesture based, at least in part on the input. In at least one example embodiment, the apparatus performs authentication based, at least in part, on the touch gesture. Since the information utilized by the apparatus in performing this type of authentication is provided for the purpose of authentication, this type of authentication may be referred to as queried authentication.

FIG. 2C is a diagram illustrating authentication according to at least one example embodiment. The example of FIG. 2C relates to authentication based, at least in part, on a motion. The example of FIG. 2C relates to authentication associated with a motion gesture. In at least one example embodiment, a motion gesture relates to input associated with motion of the apparatus, such as motion by an object holding the apparatus. The example of FIG. 2C relates to a hand holding an apparatus at start position 221A, performing motion 222, which results in the apparatus being at end position 221B. In at least one example embodiment, the motion gesture relates to movement 222. In at least one example embodiment, the motion gesture further relates to start position 221A and/or end position 221B.

Even though the example of FIG. 2C indicates a two dimensional linear motion, the motion may vary. For example, the motion may be curved, may comprise a depthwise motion, may comprise a widthwise motion, may comprise a lengthwise motion, and/or the like. Furthermore, the motion may relate to a change in orientation of the apparatus. For example, the motion may comprise a rotation around any possible axis, such as turning the apparatus, flipping the apparatus, and/or the like.

The apparatus may receive input that correlates with the input associated with motion 222. The apparatus may determine the motion based, at least in part, on motion information received from one or more motion sensors, such as one or more accelerometers, gyroscopes, positional sensors, and/or the like. The motion information may be indicative of the motion of the apparatus. The apparatus may determine a motion gesture based, at least in part on the motion information. In at least one example embodiment, the apparatus performs authentication based, at least in part, on the motion gesture. For example, the apparatus may determine a correspondence between the motion and at least part of motion authentication information. In at least one example embodiment, the correspondence relates to the motion being within a threshold of deviation from the motion authentication information. Motion authentication information may relate to authentication information indicative of a motion that serves as verification of propriety of access. Since the information utilized by the apparatus in performing this type of authentication is provided for the purpose of authentication, this type of authentication may be referred to as queried authentication.

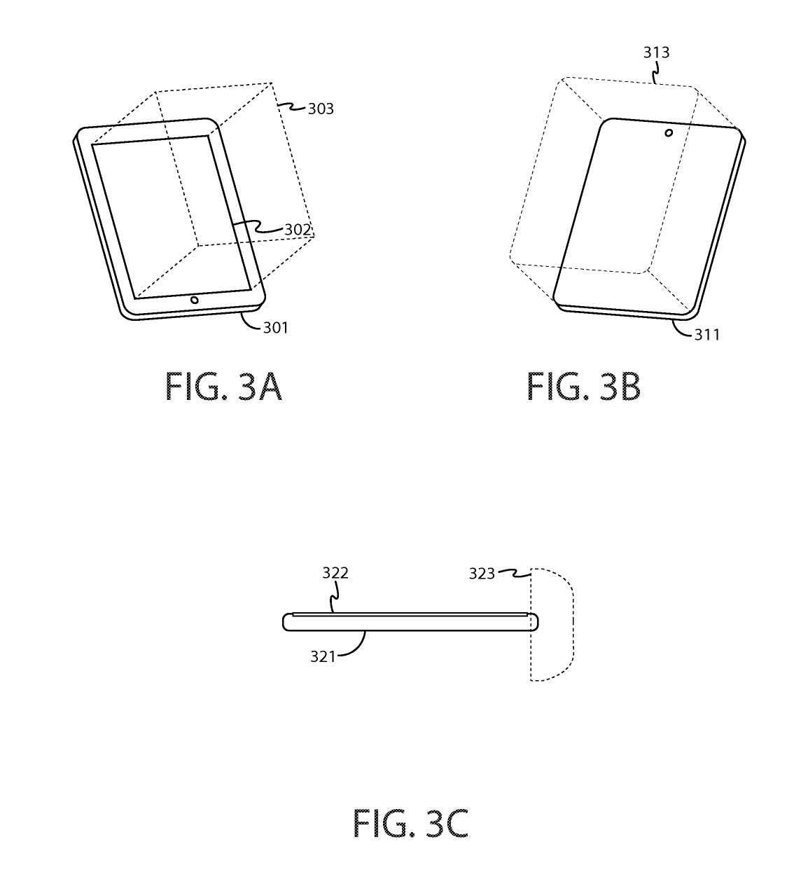

FIGS. 3A-3C are diagrams illustrating a region associated with detecting an object proximate to an apparatus according to at least one example embodiment. The examples of FIGS. 3A-3C are merely examples of such a region, and do not limit the scope of the claims. For example, type of size of the region may vary, orientation of the region may vary, relationship between the region and the apparatus may vary, and/or the like.

Improvements in sensors have allowed for detection of objects proximate to an apparatus. In addition, such sensors may be capable of determining distance of an object from the apparatus. In at least one example embodiment, a sensor may comprise a collection of individual sensors that are arranged to allow for determination of distance of multiple parts of an object from the apparatus. In this manner, the sensor may allow for determination of the contour of an object based, at least in part, on the distance of the contour from the apparatus. In at least one example embodiment, input device 13 comprises at least one such sensor.

In at least one example embodiment, the apparatus comprises a capacitive sensor that provides information indicative of the contour of an object that is proximate to the apparatus. The capacitive sensor may measure such distance by way of perceiving changes in capacitance based on proximity of the sensor to an electrically conductive object, such as a hand. In this manner, a capacitive sensor may provide sensor information that is indicative of an electrical conduction property of the object. Without limiting the scope of the claims in any way, at least one technical advantage associated with determining contour of an object based on electrical conductivity of the object may be to allow for determining contour of a hand that is covered by non-conductive material, such as a glove. Even though current capacitive sensors may allow for determination of contour of an object up to 4 cm from the apparatus, future capacitive sensors may be capable of determination of contour of an object beyond 4 cm. Therefore, the distance, between an object and the apparatus, associated with the sensor receiving sensor information indicative of the object may vary, and does not limit the claims in any way. In at least one example embodiment, an object is proximate to the apparatus if the object is at a distance from the apparatus that allows the sensor to detect a contour of, at least part of, the object. For example, if the object is a hand performing a touch input on the apparatus, at least part of the hand may be proximate to the apparatus if the at least part of the hand is detected by the sensor such that the sensor information provided by the sensor is indicative of the hand. In this manner, the sensor may detect contour of an object that is hovering proximate to the apparatus, but not necessarily touching the apparatus.

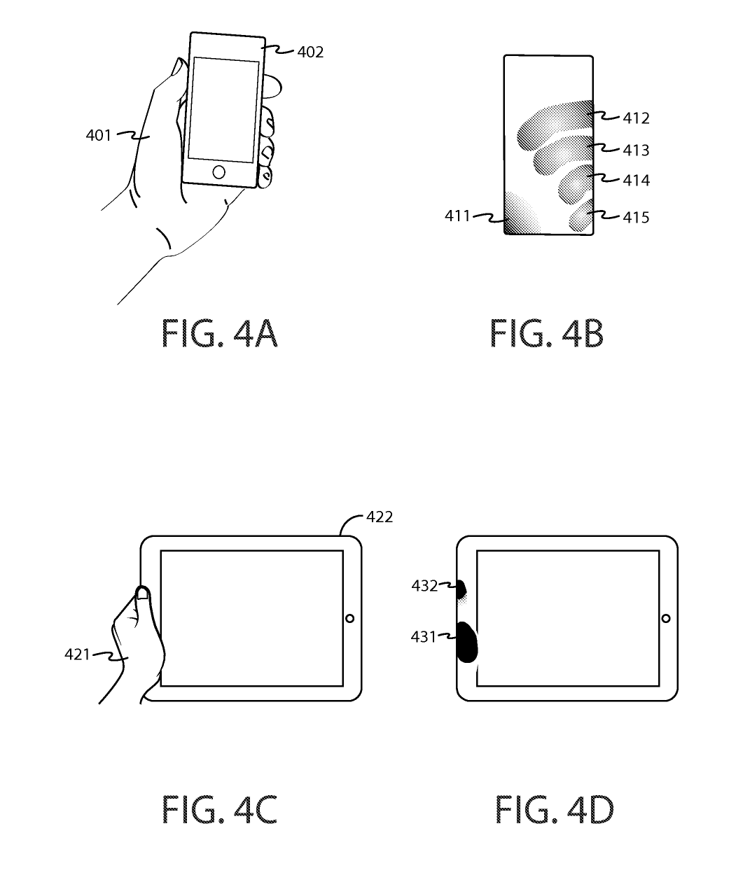

In at least one example embodiment, the apparatus may determine a three dimensional representation of an object proximate to the apparatus. The capacitive sensor may provide sensor information indicative of the object, such as sensor information indicative of an electrical conduction property of the object. In circumstances where the sensor relates to a capacitive sensor, the three dimensional representation is, at least partially, indicative of a three dimensional representation of conductivity of the object. The three dimensional representation may be similar as described regarding FIGS. 4A-4D, 5A-5D, and 6A-6C.

In at least one example embodiment, a region associated with a sensor being capable of detecting a contour of an object may be referred to as a sensor region. The sensor region may be a region extending from the apparatus to a distance associated an object no longer being considered to be proximate to the apparatus. The sensor region may resemble an area of the apparatus that corresponds to an area of the sensor. For example, the sensor may coincide with a display. In such an example, the sensor region may relate to the boundary of the display extending outward from the apparatus perpendicular to the display. In this manner, the sensor may provide sensor information indicative of the object being in front of a display. In such an example, the object being in front of the display may relate to the object being positioned such that a line normal to the display intersects with, at least part of, the object. In at least one example embodiment, the part of the object corresponds with a part of a three dimensional representation of the object. For example, the part of the object may correspond with a part of the object associated with authentication. In at least one example embodiment, the part of the object corresponds with every part of a three dimensional representation of the object that is associated with authentication based on the object. Relation between the object, a three dimensional representation of the object, and authentication may be similar as described regarding FIGS. 4A-4D, 5A-5D, and 6A-6C.

In at least one example embodiment, the object not being in front of the display relates to the object being positioned such that a line normal to the display fails to intersect with at least part of the three dimensional representation upon which authentication is based. In at least one example embodiment, the object not being in front of the display relates to the object being positioned such that a line normal to the display fails to intersect with any part of the three dimensional representation upon which the authentication is based.

Even though the examples of FIGS. 3A-3B indicate a monoblock apparatus, physical configuration of the apparatus may vary, and does not limit the claims. For example, the apparatus may comprise multiple displays, a display that wraps around a side of the apparatus, and/or the like. The apparatus may be deformable. For example, the apparatus may be bendable, compressible, foldable, openable, closable, and/or the like. The apparatus may be holdable, wearable, mountable, and/or the like.

Even though the sensor region indicated in FIGS. 3A-3C relate to a rectilinear parallelepiped, shape of the sensor region may vary and does not limit the claims. For example, cross section of the sensor region may expand outward from the apparatus, may contract inward from the apparatus, and/or the like.

FIG. 3A is a diagram illustrating a region associated with detecting an object proximate to an apparatus according to at least one example embodiment. In the example of FIG. 3A, apparatus 301 comprises a sensor that corresponds with display 302. It can be seen that sensor region 303 relates to a region that extends from the apparatus at the boundaries of display 302. In this manner, the sensor corresponds with display 302. In this manner, sensor information associated with sensor region 303 may be sensor information indicative of an object being in front of display 302.

FIG. 3B is a diagram illustrating a region associated with detecting an object proximate to an apparatus according to at least one example embodiment. In the example of FIG. 3B, apparatus 311 comprises a sensor that corresponds with a part of the apparatus that does not correspond with a display. In the example of FIG. 3B, the sensor corresponds to the back of apparatus 311. It can be seen that sensor region 313 relates to a region that extends from the apparatus from the back of apparatus 313 such that the sensor fails to correspond with a display. In this manner, sensor information associated with sensor region 313 may be sensor information indicative of an object not being in front of a display.

FIG. 3C is a diagram illustrating a region associated with detecting an object proximate to an apparatus according to at least one example embodiment. In the example of FIG. 3C, apparatus 321 comprises a sensor that corresponds with a part of the apparatus that does not correspond with a display. In the example of FIG. 3C, the sensor corresponds to a side of apparatus 321. It can be seen that sensor region 323 relates to a region that extends from the apparatus from the front, side, and back of apparatus 323 such that the sensor fails to correspond with a display. In this manner, sensor information associated with sensor region 323 may be sensor information indicative of an object not being in front of a display.

FIGS. 4A-4D are diagrams illustrating a three dimensional representation of an object according to at least one example embodiment. The examples of FIGS. 4A-4D are merely examples of a three dimensional representation of an object, and do not limit the scope of the claims. For example, color indicative of depth may vary, graphical properties of the representation may vary, data realizing the representation may vary, and/or the like.

In some circumstances, it may be desirable to allow an apparatus to perform authentication that is independent of a queried authentication. For example, it may be desirable to avoid providing information for the purpose of authentication. In such an example, the user may desire to avoid memorizing a password, taking the time to provide input for a queried authentication, and/or the like. In another example, it may be desirable to strengthen queried authentication with non-queried authentication. For example, it may be desirable to base authentication, at least in part, on information provided for purposes independent of authentication in conjunction with queried authentication.

It may be desirable to perform authentication based, at least in part, on an object that is proximate to a device. For example, it may be desirable to perform authentication based, at least in part on an object holding the apparatus, an object performing input on the apparatus, an object within the sensor region of the apparatus, and/or the like. For example, it may be desirable to perform authentication based, at least in part, on the way a user holds the apparatus, the way the user positions his hand when performing input, and/or the like. For example, authentication may be successful when the user holds the apparatus in one hand orientation, and authentication may be unsuccessful when the user holds the apparatus in a different hand orientation. Without limiting the scope of the claims in any way, at least one technical effect associated with performing authentication based, at least in part on an object proximate to the apparatus may be, to allow authentication to be based on the manner in which a user interacts with the apparatus independent of any queried authentication from the user.

In performing authentication based, at least in part, on an object proximate to the apparatus, authentication may be based, at least in part, on the manner in which a user interacts with the apparatus, such as the way the user holds the apparatus, the way the user orients his hand when performing input, and/or the like. In addition, the user may be able to hold the apparatus or orient his hand in a particular way when authentication is performed. For example, the user may hold the apparatus in one hand orientation when normally using the apparatus, and hold the apparatus in a different hand orientation for successful authentication.

Without limiting the scope of the claims in any way, at least one technical effect associated with performing authentication based, at least in part, on an object proximate to the apparatus may be to allow the user to allow for subtle and/or concealable authentication. For example, it may be difficult for a malicious party to mimic authentication based on watching the apparatus perform authentication based, at least in part, on the object. For example, if the apparatus bases authentication on the orientation of the hand performing the input, there may be parts of the hand that are not visible to the malicious party, but that may be perceivable by the sensor.

In at least one example embodiment, the apparatus bases authentication, at least in part, on sensor information indicative of an object proximate to the apparatus. In at least one example embodiment, the authentication is based, at least in part, on a three dimensional representation of the object. The apparatus may determine the three dimensional representation based, at least in part, on the sensor information. The three dimension representation of the object may be based, at least in part on the sensor information. In at least one example embodiment, the three dimensional representation comprises a three dimensional representation that correlates to a part of the object that is not in contact with the apparatus, a part of the object that is in contact with the apparatus, and/or the like. In at least one example embodiment, part of the object is not in contact with the apparatus if the object is at a distance greater than a contact threshold from the apparatus. In at least one example embodiment, the contact threshold may be based on a distance associated with clothing that may lie between the object and the apparatus, such as a glove on a hand. In at least one example embodiment, the contact threshold relates to a distance beyond which a touch sensor does not perceive input sufficient to determine that a touch input occurred.

In at least one example embodiment, the three dimensional representation relates to a representation of distance from a surface of the apparatus. In at least one example embodiment, distance may be inferred by influence of electrical conductivity on a sensor. For example, if at least part of the object is electrically conductive, the three dimensional representation may be, at least partially, indicative of a three dimensional representation of conductivity of the object. The apparatus may receive sensor information associated with a contour of the object represented by a distance between the surface of the apparatus and the object. For example, the three dimensional representation may relate to an array of values. The array may correspond to positions along the surface of the apparatus. The values may relate to a distance between the apparatus and the object at the position represented by the array. In at least one example embodiment, the three dimensional representation may indicate utilize a color to indicate such a value. In the examples of FIGS. 4A-4D, 5A-5D, and 6A-6C, a darker color is indicative of a shorter distance than that of a lighter color. In at least one example embodiment, such a color representation is referred to as a heat map. Even though the examples of FIGS. 4A-4D, 5A-5D, and 6A-6C are illustrated as bland and white images, this coloring is merely for purposes of simplicity, and does not limit the claims in any way.

In at least one example embodiment, the apparatus performs authentication based, at least in part, on at least part on the three dimensional representation. The authentication may be based at least in part on a part of the three dimensional representation that correlates to a part of the object that is not in contact with the apparatus. In this manner, the authentication may be based, at least in part, on information independent of touch sensor information. In at least one example embodiment, authentication may be based, at least in part, on correlation between the three dimensional representation and object authentication information. In at least one example embodiment, object authentication information relates to stored information that is utilized to determine whether an object is sufficiently similar to being indicative of an object associated with proper access to the apparatus. In at least one example embodiment, object authentication may relate to the object being a hand. In such circumstances, the object authentication information may comprise hand authentication information.

In at least one example embodiment, successful authentication is based, at least in part, on determination of existence of a correspondence between the three dimensional representation and at least part of object authentication information. In at least one example embodiment, the correspondence relates to the three dimensional representation being within a threshold of deviation from the object authentication information. The object authentication information may relate to identity of the object, classification of the object, orientation of the object, placement of the object, and or the like. For example, the object authentication information may indicate characteristics of a user's hand that distinguish the user's hand from one or more other user's hands. In another example, the object authentication information may relate to the object being a hand. In still another example, the object authentication information may relate to the object being a hand holding the apparatus. In yet another example, the object authentication information may relate to the object being a hand performing input on the apparatus. In another example, the object authentication information may relate to the object being a hand in a predetermined pose.

In at least one example embodiment, failed authentication is based, at least in part, on determination of a lack of correspondence between the three dimensional representation and at least part of object authentication information. In at least one example embodiment, the lack of correspondence relates to the three dimensional representation being beyond a threshold of deviation from the object authentication information.

In at least one example embodiment, performing the authentication comprises determining that the three dimensional representation is indicative of the object holding the apparatus. For example, performing authentication may comprises determining that the three dimensional representation is indicative of the object being the hand. For example, the three dimensional representation may be indicative of the object being a hand, indicative of the object being a hand holding the apparatus, indicative of the object being a hand performing input on the apparatus, and/or the like.

In at least one example embodiment, correspondence between the three dimensional representation and object authentication information may be based, at least in part, on correlation of one or more features of the three dimensional representation with one or more features of the object authentication information. In at least one example embodiment, a feature relates to a part of a three dimensional representation or object authentication information that is identifiable as a distinct part. For example, a feature may relate to a face, a thumb, a part of a face, and/or the like. For example, there may be many methods for identifying a face. The apparatus may utilize such methods, or any other suitable method, to determine that a face of the three dimensional representation corresponds with a face of the object authentication information.

In at least one example embodiment, the object information may comprise information indicative of an adornment. In at least one example embodiment, an adornment may relate to a foreign object on a user, such as jewelry, a prosthetic device, and/or the like. For example, an adornment may be a ring, a metal implant, and/or the like. In at least one example embodiment, the three dimensional representation comprises at least one indication of an adornment on a hand. In at least one example embodiment, the adornment may substantially change the electrical conductivity of a part of the user associated with authentication. For example, a ring, or a medical pin may increase the conductivity of a part of the user's hand. In this manner, the sensor information may be indicative of the adornment. For example, the adornment may be represented as being closer to the apparatus than it truly is. In this manner, such a conductive adornment may provide a pronounced feature in the three dimensional representation. It may be desirable for the apparatus to base authentication, at least in part, on the adornment.

In at least one example embodiment, performing the authentication comprises determining that the three dimensional representation is indicative of the adornment on a hand. In such an embodiment, determining successful authentication may comprise determining a correspondence between the three dimensional representation of the adornment and at least part of object authentication information. For example, the correspondence may relate to the three dimensional representation of the adornment being within a threshold of deviation from the object authentication information. In such an example, the object authentication information may relate an orientation of the adornment on the hand, a position of the adornment on the hand, an identity of the adornment, or a sensor characteristic of the adornment, and/or the like

In at least one example embodiment, determining failed authentication comprises determining a lack of correspondence between the three dimensional representation of the adornment and at least part of object authentication information. The apparatus may determine failed authentication based at least in part on the lack of correspondence. In at least one example embodiment, the lack of correspondence relates to the three dimensional representation of the adornment being beyond a threshold of deviation from the object authentication information

FIG. 4A is a diagram illustrating an object proximate to an apparatus according to at least one example embodiment. The example of FIG. 4A illustrates device 402 being held by hand 401. In the example of FIG. 4A, device 402 may comprise a sensor, such as the sensor of the example of FIG. 3B. The sensor may correspond to the back of apparatus 402. The sensor may provide sensor information indicative of hand 401 holding apparatus 402.

FIG. 4B is a diagram illustrating a three dimensional representation of an object according to at least one example embodiment. The three dimensional representation of FIG. 4B is indicative of hand 401 holding apparatus 402 in FIG. 4A. In the example of FIG. 4B, darkly shaded part of the representation relates to the representation indicating a part of an object being closer to the apparatus than a lightly shaded part of the representation. The three dimensional representation of FIG. 4B comprises features 411-412. Feature 411 corresponds to the palm of hand 401 proximate to the back of apparatus 402. The lighter shading towards the edge of feature 411 indicates that the part of the hand indicated by the lighter shading is further away from the apparatus than the part of the hand indicated by the darker shaded part of feature 411. Feature 412 relates to the index finger of hand 401. Feature 413 relates to the middle finger of hand 401. Feature 414 relates to the ring finger of hand 401. Feature 415 relates to a part of the palm of hand 401 and part of the pinky finger of hand 401.

In at least one example embodiment, the apparatus may perform authentication based, at least in part, on the three dimensional representation of FIG. 4B. For example, the apparatus may comprise object authentication information indicative of the hand holding the apparatus similarly as shown in FIG. 4A. In such an example, the apparatus may determine successful authentication based, at least in part, on determining that the three dimensional representation correlates with the object authentication information.

FIG. 4C is a diagram illustrating an object proximate to an apparatus according to at least one example embodiment. The example of FIG. 4C illustrates device 422 being held by hand 421. In the example of FIG. 4C, device 422 may comprise a sensor, such as the sensor of the example of FIG. 3A. The sensor may correspond to the front of apparatus 422. The sensor may, at least partially, correspond with the display. For example, the sensor may be associated with a part of the front side of apparatus 422 that corresponds with the display and a part of the front of apparatus 422 that does not correspond with the display. The sensor may provide sensor information indicative of hand 421 holding apparatus 422.

FIG. 4D is a diagram illustrating a three dimensional representation of an object according to at least one example embodiment. The three dimensional representation of FIG. 4D is indicative of hand 421 holding apparatus 422 in FIG. 4C. In the example of FIG. 4D, darkly shaded part of the representation relates to the representation indicating a part of an object being closer to the apparatus than a lightly shaded part of the representation. The three dimensional representation of FIG. 4D comprises features 431 and 432. Feature 431 corresponds to the palm of hand 421 proximate to the front of apparatus 422. The lighter shading towards the edge of feature 431 indicates that the part of the hand indicated by the lighter shading is further away from the apparatus than the part of the hand indicated by the darker shaded part of feature 431. Feature 432 relates to the thumb of hand 421.

In at least one example embodiment, the apparatus may perform authentication based, at least in part, on the three dimensional representation of FIG. 4D. For example, the apparatus may comprise object authentication information indicative of the hand holding the apparatus similarly as shown in FIG. 4C. In such an example, the apparatus may determine successful authentication based, at least in part, on determining that the three dimensional representation correlates with the object authentication information.

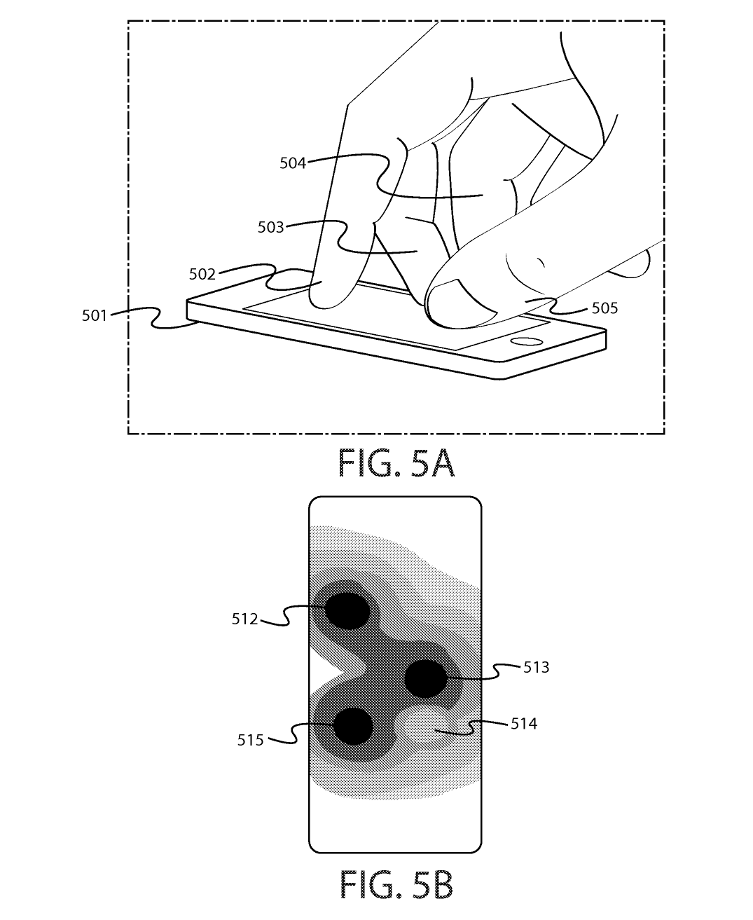

FIGS. 5A-5D are diagrams illustrating a three dimensional representation of an object according to at least one example embodiment. The examples of FIGS. 5A-5D are merely examples of a three dimensional representation of an object, and do not limit the scope of the claims. For example, color indicative of depth may vary, graphical properties of the representation may vary, data realizing the representation may vary, and/or the like.

As previously discussed, it may be desirable to perform authentication based, at least in part, on an object associated with performing an input. The authentication may be similar as described regarding FIGS. 4A-4D. In at least one example embodiment, the apparatus comprises one or more sensors for detecting the object. The sensors may be configured to receive sensor information regarding the object being proximate to an input device, such as a touch display, similar as described in FIG. 3A.

In at least one example embodiment, the apparatus performs authentication based, at least in part, on an object performing an input. In at least one example embodiment, the apparatus may determine a three dimensional representation of the object performing the input. In some circumstances, the three dimensional representation may be indicative of a hand performing the input.

FIG. 5A is a diagram illustrating an object proximate to an apparatus according to at least one example embodiment. The example of FIG. 5A illustrates a hand performing input on apparatus 501. It can be seen that fingers 502, 503, and 505 are in contact with the apparatus. Fingers 502, 503, and 504 may be performing an input on the apparatus. It can be seen that finger 504 is proximate to apparatus 501, but not in contact with apparatus 501. In at least some circumstances, finger 504 is not performing an input on apparatus 501. In at least some circumstances, finger 504 is performing an input on apparatus 501.

FIG. 5B is a diagram illustrating a three dimensional representation of an object according to at least one example embodiment. The three dimensional representation of FIG. 5B is indicative of the hand performing the input on apparatus 501 in FIG. 5A. In the example of FIG. 5B, darkly shaded part of the representation relates to the representation indicating a part of an object being closer to the apparatus than a lightly shaded part of the representation. The three dimensional representation of FIG. 5B comprises features 512-515. Feature 512 corresponds to parts of finger 502 that are proximate to, and in contact with, apparatus 501. The lighter shading towards the edge of feature 512 indicates that the part of the finger indicated by the lighter shading is further away from the apparatus than the part of the finger indicated by the darker shaded part of feature 512. Feature 513 corresponds to parts of finger 503 that are proximate to, and in contact with, apparatus 501. Feature 515 corresponds to parts of finger 505 that are proximate to, and in contact with, apparatus 501. Feature 512 corresponds to parts of finger 502 that are proximate to, and in contact with, apparatus 501. Feature 514 corresponds to parts of finger 504 that are proximate to apparatus 501. It can be seen that the darkest shading of feature 514 indicates that finger 504 is not in contact with apparatus 501.

In at least one example embodiment, the apparatus may perform authentication based, at least in part, on the three dimensional representation of FIG. 5B. For example, the apparatus may comprise object authentication information indicative of the hand performing input similarly as shown in FIG. 5A. In such an example, the apparatus may determine successful authentication based, at least in part, on determining that the three dimensional representation correlates with the object authentication information. In at least one example embodiment, the apparatus may perform authentication based, at least in part, on feature 514, even though feature 514 may be unassociated with the performance of input.

FIG. 5C is a diagram illustrating an object proximate to an apparatus according to at least one example embodiment. The example of FIG. 5C illustrates a hand performing input on apparatus 521, and hand 524 holding apparatus 521. It can be seen that finger 522 is in contact with the apparatus. Finger 522 may be performing an input on the apparatus. It can be seen that finger 523 is proximate to, but not in contact with, apparatus 521. In at least some circumstances, finger 523 is not performing an input on apparatus 521. In at least some circumstances, finger 523 is performing an input on apparatus 521.

FIG. 5D is a diagram illustrating a three dimensional representation of an object according to at least one example embodiment. The three dimensional representation of FIG. 5D is indicative of the hand performing the input on apparatus 521 in FIG. 5C. In the example of FIG. 5D, darkly shaded part of the representation relates to the representation indicating a part of an object being closer to the apparatus than a lightly shaded part of the representation. The three dimensional representation of FIG. 5D comprises features 532 and 533. Feature 532 corresponds to parts of finger 522 that are proximate to, and in contact with, apparatus 521. The lighter shading towards the edge of feature 532 indicates that the part of the finger indicated by the lighter shading is further away from the apparatus than the part of the finger indicated by the darker shaded part of feature 532. Feature 533 corresponds to parts of finger 523 that are proximate to apparatus 521. It can be seen that the darkest shading of feature 533 indicates that finger 523 is not in contact with apparatus 521.

In at least one example embodiment, the apparatus may perform authentication based, at least in part, on the three dimensional representation of FIG. 5D. For example, the apparatus may comprise object authentication information indicative of the hand performing input similarly as shown in FIG. 5C. In such an example, the apparatus may determine successful authentication based, at least in part, on determining that the three dimensional representation correlates with the object authentication information. In at least one example embodiment, the apparatus may perform authentication based, at least in part, on feature 533, even though feature 533 may be unassociated with the performance of input.

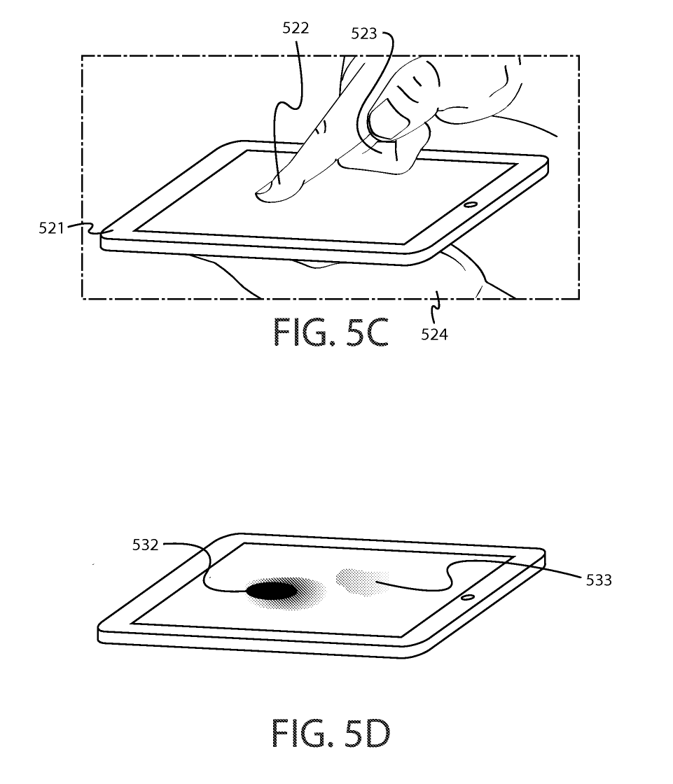

FIGS. 6A-6C are diagrams illustrating a three dimensional representation of an object according to at least one example embodiment. The examples of FIGS. 6A-6C are merely examples of a three dimensional representation of an object, and do not limit the scope of the claims. For example, color indicative of depth may vary, graphical properties of the representation may vary, data realizing the representation may vary, and/or the like.

In some circumstances, it may be desirable to perform authentication based, at least in part, on parts of an object that do not fit within a sensor region. For example, it may be desirable to perform authentication based on a part of a user's body, such as the user's face, or arm, that does not fit within a scan region. In such circumstances, the user may be able to move the apparatus along the object such that the object passes through the scan region.

In at least one example embodiment, an apparatus performs authentication based, at least in part, on an object proximate to the apparatus that is larger than a sensor region of the apparatus. In at least one example embodiment, the apparatus determines a three dimensional representation of the object that is larger than the sensor region. In at least one example embodiment, the apparatus may combine sensor information associated with one part of an object and sensor information associated with another part of the object. The part of the object and the other part of the object may be greater than a distance encompassed by the sensor region. In such circumstances, the apparatus may combine sensor information associated with information received regarding the one part with different sensor information regarding the other part. The sensor information and the different sensor information may be received at different times. For example, the sensor information may be received at a time when the user is holding the apparatus over his hand, and the different sensor information may be received while the user is holding the apparatus over his arm.

In at least one example embodiment, the apparatus may determine the three dimensional representation of the object based, at least in part, on a previously determined three dimensional representation and additional sensor information. For example, the apparatus may determine a three dimensional representation associated with a first part of an object. In such an example, the apparatus may determine another three dimensional representation of the object based, at least in part, on the three dimensional representation, additional sensor information, and information indicative of movement. In at least one example embodiment, information indicative of movement relates to information that allows the apparatus to determine that movement occurred. For example, information indicative of movement may relate to sensor information indicative of a feature being at a different position in relation to the apparatus. In another example, information indicative of movement may relate to information received from a motion sensor, such as an accelerometer, a gyroscope, a positioning sensor, and/or the like. Even though the example of FIGS. 6A-6C relate to a face of a user, any object may be used.

FIG. 6A is a diagram illustrating an object proximate to an apparatus according to at least one example embodiment. The example of FIG. 6A illustrates a user holding apparatus 602 in front of his face 601. The user may be holding apparatus 602 such that a first part of face 601 is within a sensor region of apparatus 602. For example, the eyes of the user may be within the sensor region. In the example of FIG. 6A, other parts of face 601 may be outside of the sensor region.

In at least one example embodiment, apparatus 602 may receive sensor information indicative of the part of face 601 that is within the sensor region. Apparatus 602 may determine a three dimensional representation of the part of the face associated with the sensor information. In at least one example embodiment, the three dimensional representation may be insufficient for successful authentication. For example, the three dimensional representation may be insufficient for successful authentication due to absence of features associated with authentication information.

FIG. 6B is a diagram illustrating an object proximate to an apparatus according to at least one example embodiment. The example of FIG. 6B illustrates a user holding apparatus 602 in front of his face 601 at a lower position that that of FIG. 6A. The user may be holding apparatus 602 such that a second part of face 601 is within the sensor region of apparatus 602. For example, the mouth of the user may be within the sensor region. In the example of FIG. 6B, other parts of face 601 may be outside of the sensor region. In at least one example embodiment, the apparatus may receive information indicative of movement based, at least in part, on the movement of apparatus 602 from the position of FIG. 6A to the position of FIG. 2B. For example, the information indicative of movement may relate to movement of a feature, such as the nose of face 601, information associated with a motion sensor, and/or the like.

The example of FIG. 6B relates to a situation where the user has moved apparatus 602 from the position indicated by FIG. 6A. In at least one example embodiment, apparatus 602 may receive additional sensor information indicative of the part of face 601 that is within the sensor region. Apparatus 602 may determine a different three dimensional representation of the parts of the face associated with the additional sensor information, the information indicative of the movement, and the three dimensional representation. In at least one example embodiment, the different three dimensional representation may be sufficient for successful authentication. For example, the three dimensional representation may be sufficient for successful authentication due to inclusion of one or more features that are associated with sensor information associated with the position of apparatus in FIG. 6A, but unrepresented in the additional sensor information.

FIG. 6C is a diagram illustrating a three dimensional representation of an object according to at least one example embodiment. The example of FIG. 6C relates to a three dimensional representation of face 601. The three dimensional representation of FIG. 6C may be the different three dimensional representation described in regards to FIG. 6B.

In some circumstances, it may be desirable to perform authentication based, at least in part, on an object proximate to the apparatus and a different criteria. For example, the apparatus may perform a first authentication based, at least in part, on the three dimensional representation and a second authentication. The terms first and second are merely used to differentiate distinct authentications. For example, the first authentication may be performed after the second authentication, may be performed concurrently with the second authentication, or may be performed before the second authentication. In at least one example embodiment, successful authentication may be predicated upon the first authentication being successful and the second authentication being successful. For example, performing authentication may comprise determining successful authentication based, at least in part, on determination that the first authentication was successful and the second authentication was successful. In at least one example embodiment, the second authentication is independent of the three dimensional representation associated with the first authentication.

In at least one example embodiment, the second authentication relates to a motion associated with the object. For example, the first authentication may relate to an object holding the apparatus, similar as described regarding FIGS. 4A-4D, and the second authentication may relate to a motion gesture, similar as described regarding FIG. 2C, an input, similar as described regarding FIGS. 2A-2B, a force input, and/or the like. For example, the second authentication may relate to the amount of force applied by the object holding the apparatus.

In at least one example embodiment, the second authentication is based, at least in part, on a different three dimensional representation of a different object than the first authentication. For example, the first authentication may relate to an object holding the apparatus, and the second authentication may relate to an object performing input on the apparatus, similar as described regarding FIGS. 5A-5D. In another example, the first authentication may relate to an object holding the apparatus, and the second authentication may relate to an object larger than a sensor region, similar as described regarding FIGS. 6A-6C.

In at least one example embodiment, the second authentication relates to input associated with the object. For example, the second authentication may relate to a contact input associated with the object. For example, the first authentication may relate to an object performing input, similar as described regarding FIGS. 5A-5D, and the second authentication may relate to the input being performed, similar as described regarding FIGS. 2A-2B.

In some circumstances, it may be desirable to perform authentication based, at least in part, on an object proximate to the apparatus, a different criteria, and another different criteria. For example, the apparatus may perform a first authentication based, at least in part, on the three dimensional representation, a second authentication, and a third authentication. The terms first, second, and third are merely used to differentiate distinct authentications. In at least one example embodiment, successful authentication may be predicated upon the first authentication being successful, the second authentication being successful, and the third authentication being successful. For example, performing authentication may comprise determining successful authentication based, at least in part, on determination that the first authentication was successful, determination that the second authentication was successful, and determination that the third authentication was successful. In at least one example embodiment, the third authentication is independent of the three dimensional representation associated with the first authentication and/or the second authentication.

In at least one example embodiment, the first authentication may relate to authentication based, at least in part, on an object holding the apparatus, similar as described regarding FIGS. 4A-4D, the second authentication may be based, at least in part, on an object performing input, similar as described regarding FIGS. 5A-5D, and the third authentication may be based, at least in part, on the input being performed, similar as described regarding FIGS. 2A-2B. For example, in the example illustrated by FIG. 5C, the apparatus may perform a first authentication based, at least in part, on hand 524, may perform the second authentication based, at least in part on the hand comprising fingers 522 and 523, and may perform the third authentication based, at least in part, on the input being performed by the hand comprising fingers 522 and 523.

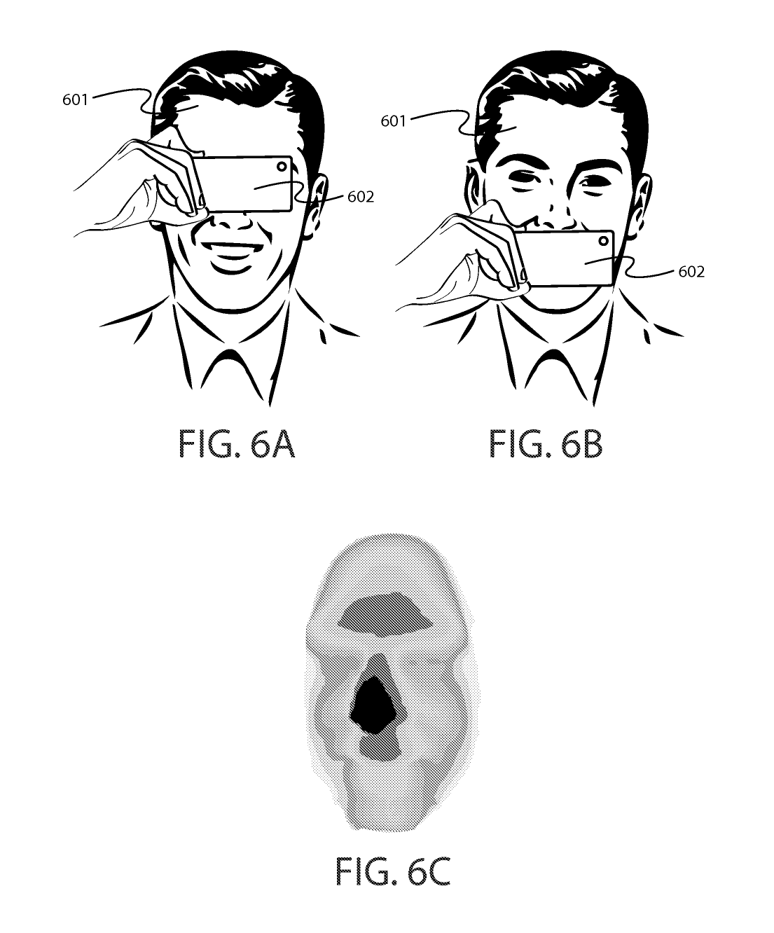

FIG. 7 is a flow diagram illustrating activities associated with performing authentication according to at least one example embodiment. In at least one example embodiment, there is a set of operations that corresponds the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

At block 702, the apparatus determines at least one three dimensional representation of at least one object proximate to an apparatus. The determination, the three dimensional representation, the object, and proximity to the apparatus may be similar as described in FIGS. 3A-3C, 4A-4D, 5A-5D, and 6A-6C.

At block 704, the apparatus performs authentication based, at least in part, on the three dimensional representation. The authentication may be similar as described regarding FIGS. 2A-2C, 4A-4D, 5A-5D, and 6A-6C.

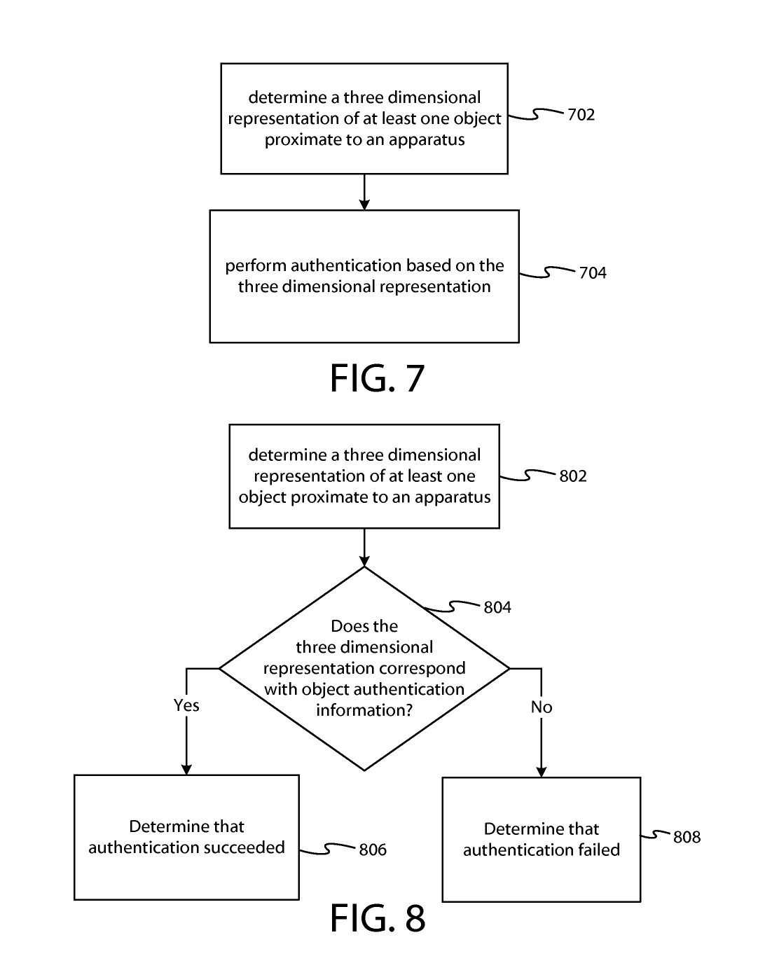

FIG. 8 is a flow diagram illustrating activities associated with performing authentication according to at least one example embodiment. In at least one example embodiment, there is a set of operations that corresponds the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

At block 802, the apparatus determines at least one three dimensional representation of at least one object proximate to an apparatus, similarly as described regarding block 702 of FIG. 7. At block 804, the apparatus determines whether the three dimensional representation corresponds with object authentication information. The determination, the correspondence, and the object authentication information may be similar as described regarding FIGS. 2A-2C, 4A-4D, 5A-5D, and 6A-6C. If the apparatus determines existence of a correspondence between the three dimensional representation and at least part of object authentication information, flow proceeds to block 806. If the apparatus determines a lack of correspondence between the three dimensional representation and at least part of object authentication information, flow proceeds to block 808.

At block 806, the apparatus determines that authentication succeeded. In this manner, determination of successful authentication may be based, at least in part, on the correspondence between the three dimensional representation and at least part of object authentication information. Successful authentication may be similar as described regarding FIGS. 2A-2C, 4A-4D, 5A-5D, and 6A-6C.

At block 808, the apparatus determines that authentication failed. In this manner, determination of failed authentication may be based, at least in part, on the lack of correspondence between the three dimensional representation and at least part of object authentication information

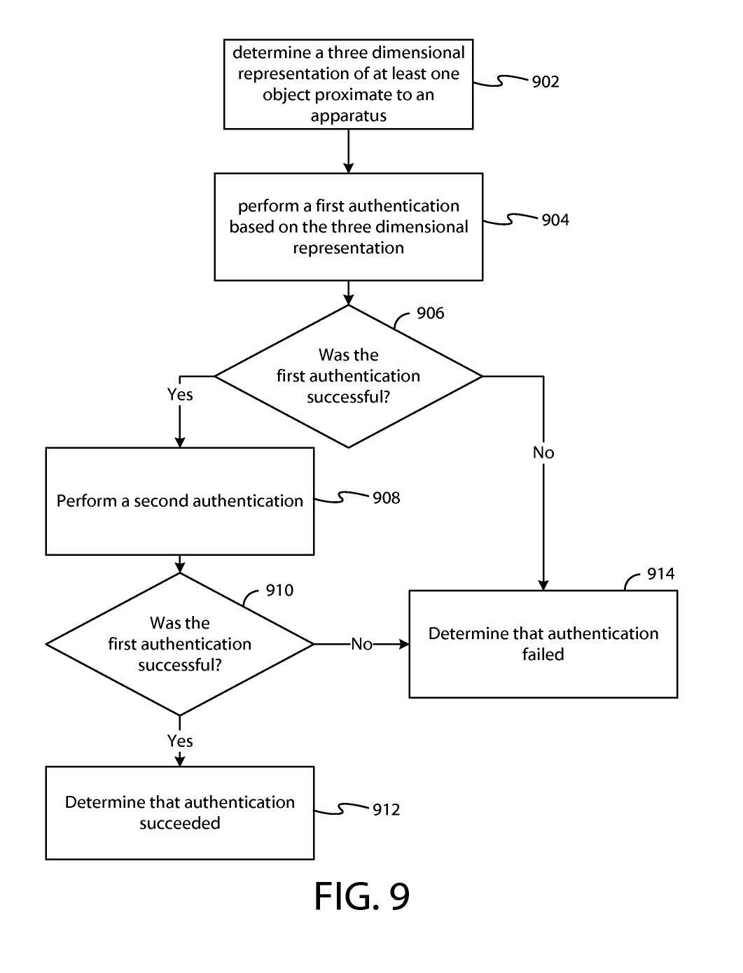

FIG. 9 is a flow diagram illustrating activities associated with performing authentication according to at least one example embodiment. In at least one example embodiment, there is a set of operations that corresponds the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

The example of FIG. 9 relates to a first authentication and a second authentication. As previously stated, the terms first and second are merely used to differentiate distinct authentications. For example, the first authentication may be performed after the second authentication, may be performed concurrently with the second authentication, or may be performed before the second authentication.

At block 902, the apparatus determines at least one three dimensional representation of at least one object proximate to an apparatus, similarly as described regarding block 702 of FIG. 7. At block 904, the apparatus performs a first authentication based, at least in part, on the three dimensional representation. The first authentication may be similar as described regarding FIGS. 2A-2C, 4A-4D, 5A-5D, and 6A-6C. At block 906, the apparatus determines whether the first authentication was successful. Successful authentication may be similar as described regarding FIGS. 2A-2C, 4A-4D, 5A-5D, and 6A-6C. If the apparatus determines that the first authentication was successful, flow proceeds to block 908. If the apparatus determines that the first authentication was unsuccessful, flow proceeds to block 914.

At block 908, the apparatus performs a second authentication. The second authentication may be similar as described regarding FIGS. 2A-2C, 4A-4D, 5A-5D, and 6A-6C. At block 910, the apparatus determines whether the second authentication was successful. Successful authentication may be similar as described regarding FIGS. 2A-2C, 4A-4D, 5A-5D, and 6A-6C. If the apparatus determines that the second authentication was successful, flow proceeds to block 912. If the apparatus determines that the first authentication was unsuccessful, flow proceeds to block 914.

At block 912, the apparatus determines that authentication succeeded. Successful authentication may be similar as described regarding block 806 of FIG. 8. In this manner, successful authentication may be based, at least in part, on determination that the first authentication was successful and the second authentication was successful.

At block 914, the apparatus determines that authentication failed. Failed authentication may be similar as described regarding block 808 of FIG. 8. In this manner, failed authentication may be based, at least in part, on determination that the first authentication failed or the second authentication failed.

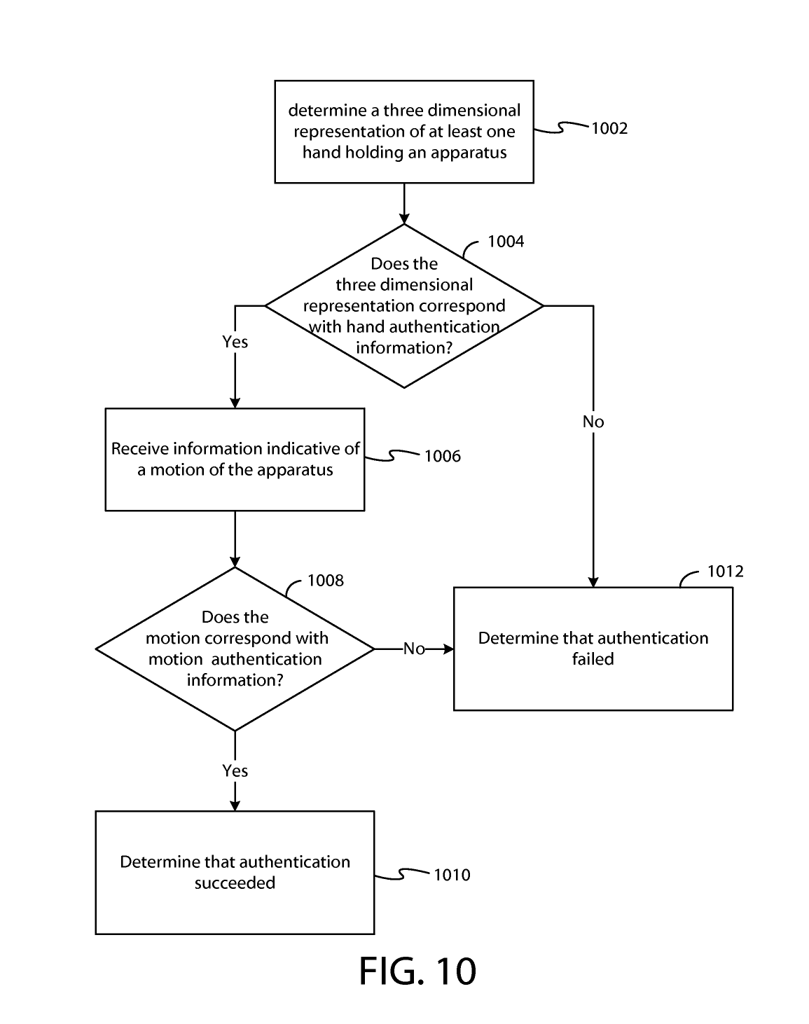

FIG. 10 is a flow diagram illustrating activities associated with performing authentication according to at least one example embodiment. In at least one example embodiment, there is a set of operations that corresponds the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

At block 1002, the apparatus determines a three dimensional representation is indicative of an object, such as a hand, holding the apparatus. The determination, the three dimensional representation, and the indication of the object may be similar as described regarding FIGS. 3A-3C, 4A-4D, 5A-5D, and 6A-6C. In at least one example embodiment, determining a three dimensional representation indicative of an object, such as a hand, holding the apparatus comprises determining the three dimensional representation and determining that the three dimensional representation is indicative of at least one object holding the apparatus.

At block 1004, the apparatus determines whether the three dimensional representation corresponds with hand authentication information. The correspondence and the hand authentication information may be similar as described regarding FIGS. 2A-2C. If the apparatus determines that the three dimensional representation corresponds with hand authentication information, flow proceeds to block 1006. If the apparatus determines that the three dimensional representation fails to correspond with hand authentication information, flow proceeds to block 1012.

At block 1006, the apparatus receives information indicative of a motion of the apparatus. The information indicative of the motion may be similar as described regarding FIG. 2C. At block 1008, the apparatus determines whether the information indicative of the motion corresponds with motion authentication information. The motion authentication information may be similar as described regarding FIG. 2C. If the apparatus determines a correspondence between the motion and at least part of motion authentication information, flow proceeds to block 1010. If the apparatus determines a lack of correspondence between the motion and at least part of motion authentication information, flow proceeds to block 1012.

At block 1010, the apparatus determines that authentication succeeded. Successful authentication may be similar as described regarding block 806 of FIG. 8. In this manner, determining successful authentication may be based at least in part on the correspondence between the three dimensional representation and the hand authentication information and correspondence between the information indicative of motion and the motion authentication information.

At block 1012, the apparatus determines that authentication failed. Failed authentication may be similar as described regarding block 808 of FIG. 8. In this manner, failed authentication may be based, at least in part, on lack of correspondence between the three dimensional representation and the hand authentication information or lack of correspondence between the information indicative of motion and the motion authentication information.

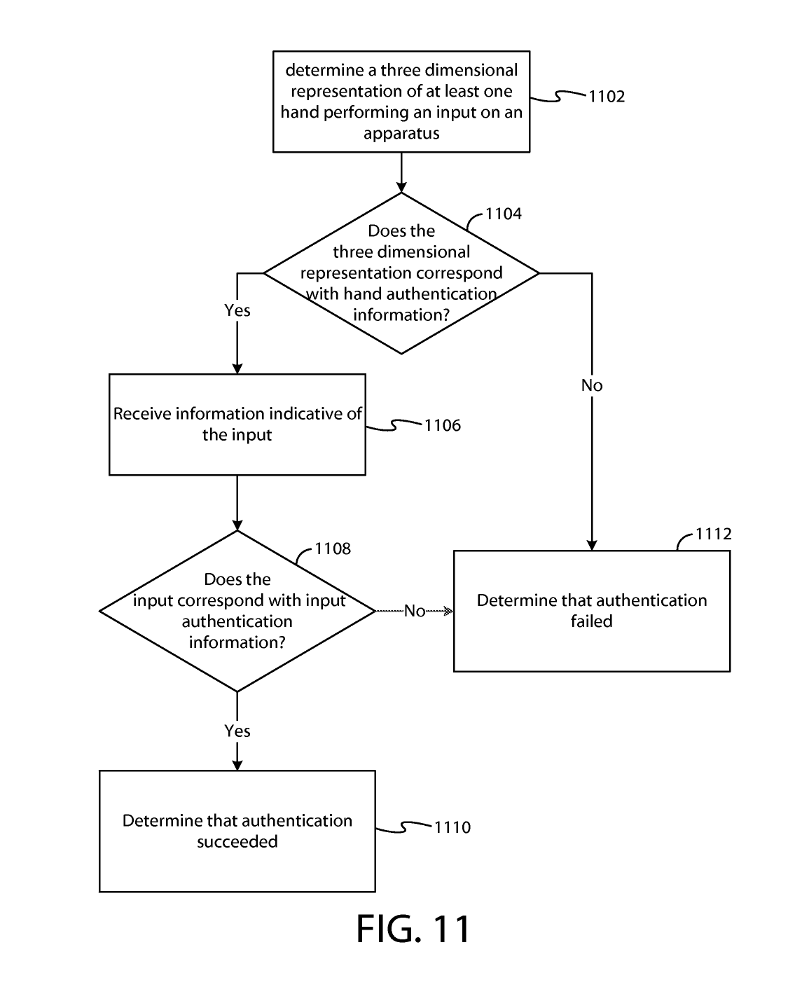

FIG. 11 is a flow diagram illustrating activities associated with performing authentication according to at least one example embodiment. In at least one example embodiment, there is a set of operations that corresponds the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

At block 1102, the apparatus determines a three dimensional representation of at least one object, such as a hand, performing an input on an apparatus. The determination, the three dimensional representation, and the indication of the object may be similar as described regarding FIGS. 3A-3C, 4A-4D, 5A-5D, and 6A-6C. In at least one example embodiment, determining a three dimensional representation indicative of an object, such as a hand, performing input on the apparatus comprises determining the three dimensional representation and determining that the three dimensional representation is indicative of at least one object performing input on the apparatus.

At block 1104, the apparatus determines whether the three dimensional representation corresponds with hand authentication information, similarly as described regarding block 1004 of FIG. 10. If the apparatus determines that the three dimensional representation corresponds with hand authentication information, flow proceeds to block 1106. If the apparatus determines that the three dimensional representation fails to correspond with hand authentication information, flow proceeds to block 1112.

At block 1106, the apparatus receives information indicative of the input. The input may be similar as described regarding FIGS. 2A-2B. At block 1108, the apparatus determines whether the input corresponds with input authentication information. The correspondence and the input authentication information may be similar as described regarding FIGS. 2A-2B. If the apparatus determines that the input corresponds with the input authentication information, flow proceeds to block 1110. If the apparatus determines that the input fails to correspond with the input authentication information, flow proceeds to block 1112.

At block 1110, the apparatus determines that authentication succeeded. Successful authentication may be similar as described regarding block 806 of FIG. 8. In this manner, determining successful authentication may be based at least in part on the correspondence between the three dimensional representation and the hand authentication information and correspondence between the input and the input authentication information.

At block 1112, the apparatus determines that authentication failed. Failed authentication may be similar as described regarding block 808 of FIG. 8. In this manner, failed authentication may be based, at least in part, on lack of correspondence between the three dimensional representation and the hand authentication information or lack of correspondence between the input and the input authentication information.

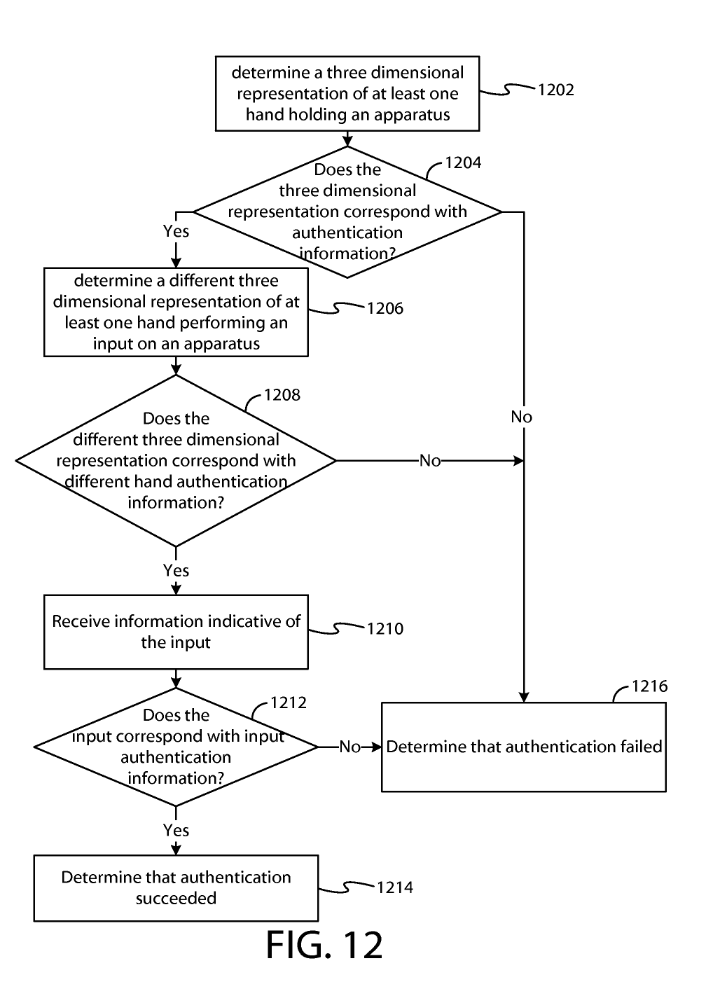

FIG. 12 is a flow diagram illustrating activities associated with performing authentication according to at least one example embodiment. In at least one example embodiment, there is a set of operations that corresponds the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12.

At block 1202, the apparatus a three dimensional representation is indicative of an object, such as a hand, holding the apparatus, similarly as described regarding block 1002 of FIG. 10. At block 1204, the apparatus determines whether the three dimensional representation corresponds with hand authentication information, similarly as described regarding block 1204 of FIG. 12. If the apparatus determines that the three dimensional representation corresponds with hand authentication information, flow proceeds to block 1206. If the apparatus determines that the three dimensional representation fails to correspond with hand authentication information, flow proceeds to block 1216.

At block 1206, the apparatus determines a different three dimensional representation of at least one object, such as a hand, performing an input on an apparatus, similarly as described regarding block 1102 of FIG. 11. At block 1208, the apparatus determines whether the different three dimensional representation corresponds with different hand authentication information, similarly as described regarding block 1104 of FIG. 11. If the apparatus determines that the different three dimensional representation corresponds with different hand authentication information, flow proceeds to block 1210. If the apparatus determines that the different three dimensional representation fails to correspond with different hand authentication information, flow proceeds to block 1216.

At block 1210, the apparatus receives information indicative of the input, similarly as described regarding block 1106 of FIG. 11. At block 1212, the apparatus determines whether the input corresponds with input authentication information, similarly as described regarding block 1108 of FIG. 11. If the apparatus determines that the input corresponds with the input authentication information, flow proceeds to block 1214. If the apparatus determines that the input fails to correspond with the input authentication information, flow proceeds to block 1216.

At block 1214, the apparatus determines that authentication succeeded. Successful authentication may be similar as described regarding block 806 of FIG. 8. In this manner, determining successful authentication may be based at least in part on the correspondence between the three dimensional representation and the hand authentication information, correspondence between the different three dimensional representation and the different hand authentication information, and correspondence between the input and the input authentication information.

At block 1216, the apparatus determines that authentication failed. Failed authentication may be similar as described regarding block 808 of FIG. 8. In this manner, determining failed authentication may be based at least in part on the lack of correspondence between the three dimensional representation and the hand authentication information, the lack of correspondence between the different three dimensional representation and the different hand authentication information, or the lack of correspondence between the input and the input authentication information.

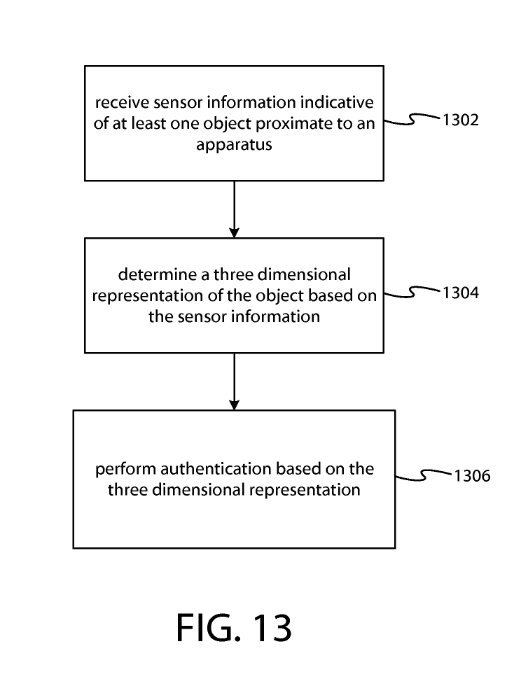

FIG. 13 is a flow diagram illustrating activities associated with performing authentication according to at least one example embodiment. In at least one example embodiment, there is a set of operations that corresponds the activities of FIG. 13. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 13.

At block 1302, the apparatus receives sensor information indicative of an object proximate to the apparatus. The sensor information, the object, and proximity to the apparatus may be similar as described regarding FIGS. 3A-3C, 4A-4D, 5A-5D, and 6A-6C. At block 1304, the apparatus determines a three dimensional representation of the object based, at least in part, on the sensor information. The determination and the three dimensional representation may be similar as described regarding FIGS. 3A-3C, 4A-4D, 5A-5D, and 6A-6C. At block 1306, the apparatus performs authentication based, at least in part, on the three dimensional representation, similarly as described regarding block 704 of FIG. 7.

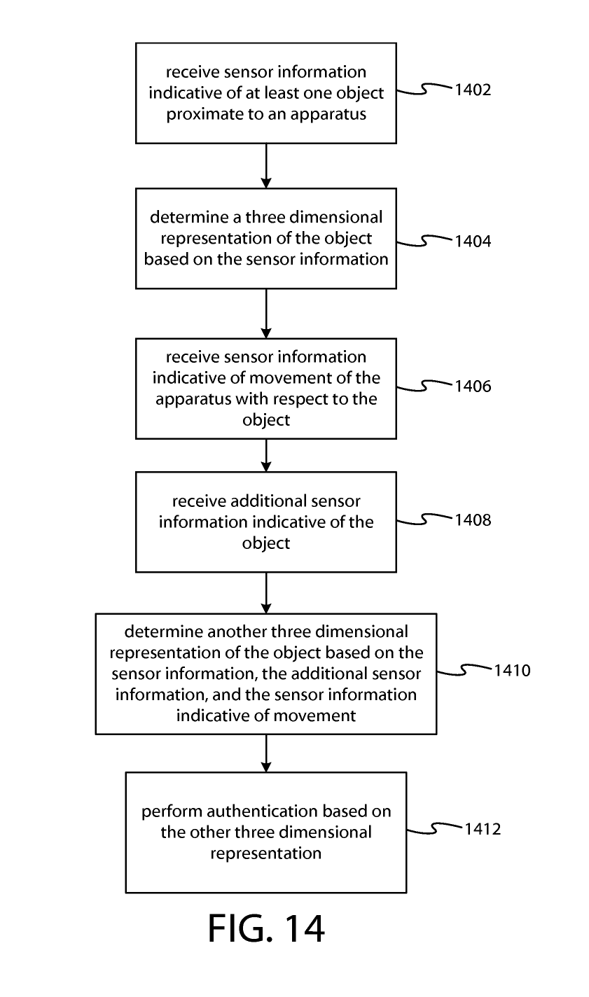

FIG. 14 is a flow diagram illustrating activities associated with performing authentication according to at least one example embodiment. In at least one example embodiment, there is a set of operations that corresponds the activities of FIG. 14. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 14.

At block 1402, the apparatus receives sensor information indicative of an object proximate to the apparatus, similarly as described regarding block 1302 of FIG. 13. At block 1404, the apparatus determines a three dimensional representation of the object based, at least in part, on the sensor information, similarly as described regarding block 1304 of FIG. 13. At block 1406, the apparatus receives sensor information indicative of movement of the apparatus with respect to the object. The sensor information and the movement may be similar as described regarding FIGS. 6A-6C.

At block 1408, the apparatus receives additional sensor information. The additional sensor information may be similar as described regarding FIGS. 6A-6C. At block 1410, the apparatus determines another three dimensional representation of the object based, at least in part, on the sensor information, the additional sensor information, and the sensor information indicative of movement. The determination may be similar as described regarding FIGS. 6A-6C.

At block 1412, the apparatus performs authentication based, at least in part, on the other three dimensional representation, similarly as described regarding block 704 of FIG. 7.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 1004 of FIG. 10 may be performed after block 1006. Furthermore, if desired, one or more of the above-described functions may be optional or may be combined. For example, blocks 1204, 1206, 1208, 1210, 1212, 1214, and 1216 of FIG. 12 may be optional and/or combined with block 704 of FIG. 7.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1. An apparatus, comprising:
at least one processor;
at least one memory including computer program code, the memory and the computer program code configured to, working with the processor, cause the apparatus to perform at least the following:
determining at least one three dimensional representation of at least one object proximate to the apparatus; and
performing authentication, the authentication comprising:
a first authentication based, at least in part, on the three dimensional representation; and
a second authentication that is independent of the three dimensional representation.

2. The apparatus of claim 1, wherein performing authentication comprises:
determining a correspondence between the three dimensional representation and at least part of object authentication information; and
determining successful authentication based at least in part on the correspondence.

3. The apparatus of claim 1, wherein the second authentication is based, at least in part, on a different three dimensional representation of a different object.

4. The apparatus of claim 1, wherein the second authentication comprises:
determining a correspondence between a motion associated with the object and at least part of motion authentication information; and
determining successful authentication based at least in part on the correspondence.

5. The apparatus of claim 1, wherein performing authentication comprises determining successful authentication based, at least in part, on determination that the first authentication was successful and the second authentication was successful.

6. The apparatus of claim 1, wherein the three dimensional representation is indicative of the object being a hand performing input on the apparatus.

7. The apparatus of claim 1, wherein the three dimensional representation comprises at least one indication of an adornment on the hand.

8. The apparatus of claim 1, the memory further including computer program code configured to cause the apparatus to perform:
receiving sensor information indicative of the object;
determining the three dimensional representation based, at least in part, on the sensor information;
receiving sensor information indicative of movement of the apparatus with respect to the object;
receiving additional sensor information; and
determining another three dimensional representation based at least in part on the three dimensional information, the sensor information, and the sensor information indicative of movement, wherein the authentication is based, at least in part on the other three dimensional representation.

9. The apparatus of claim 1, wherein the apparatus is a mobile phone.

10. A method comprising:
determining at least one three dimensional representation of at least one object proximate to an apparatus; and
performing authentication, the authentication comprising:
a first authentication based, at least in part, on the three dimensional representation; and
a second authentication that is independent of the three dimensional representation.

11. The method of claim 10, wherein performing authentication comprises:
determining a correspondence between the three dimensional representation and at least part of object authentication information; and
determining successful authentication based at least in part on the correspondence.

12. The method of claim 10, wherein the second authentication is based, at least in part, on a different three dimensional representation of a different object.

13. The method of claim 10, wherein the second authentication comprises:
determining a correspondence between a motion associated with the object and at least part of motion authentication information; and
determining successful authentication based at least in part on the correspondence.

14. The method of claim 10, wherein performing authentication comprises determining successful authentication based, at least in part, on determination that the first authentication was successful and the second authentication was successful.

15. The method of claim 10, wherein the three dimensional representation is indicative of the object being a hand performing input on the apparatus.

16. The method of claim 10, further comprising:
receiving sensor information indicative of the object;
determining the three dimensional representation based, at least in part, on the sensor information;
receiving sensor information indicative of movement of the apparatus with respect to the object;
receiving additional sensor information; and
determining another three dimensional representation based at least in part on the three dimensional information, the sensor information, and the sensor information indicative of movement, wherein the authentication is based, at least in part on the other three dimensional representation.

17. At least one computer-readable medium encoded with instructions that, when executed by a computer, perform:
determining at least one three dimensional representation of at least one object proximate to an apparatus; and
performing authentication, the authentication comprising:
a first authentication based, at least in part, on the three dimensional representation; and
a second authentication that is independent of the three dimensional representation.

18. The medium of claim 17, wherein performing authentication comprises:
determining a correspondence between the three dimensional representation and at least part of object authentication information; and
determining successful authentication based at least in part on the correspondence.

19. The medium of claim 17, wherein the second authentication is based, at least in part, on a different three dimensional representation of a different object.

20. The medium of claim 17, wherein the second authentication comprises:
determining a correspondence between a motion associated with the object and at least part of motion authentication information; and
determining successful authentication based at least in part on the correspondence.
